(19) United States
(12) Patent Application Publication
(10) Pub. No.: US 2026/0203657 A1
(43) Pub. Date: Jul. 16, 2026

(54) KNOWLEDGE TRANSFER-DRIVEN METHOD AND DEVICE FOR COMPUTING POWER ENERGY EFFICIENCY MODELING FOR DATA CENTERS

(71) Applicant: SOUTH CHINA UNIVERSITY OF TECHNOLOGY, Guangdong (CN)

(72) Inventors: Weiwei LIN, Guangdong (CN); Ruichao MO, Guangdong (CN); Haocheng ZHONG, Guangdong (CN); Shengsheng LIN, Guangdong (CN)

(21) Appl. No.: 19/140,389

(22) PCT Filed: Jul. 13, 2024
(86) PCT No.: PCT/CN2024/105376

§ 371 Date: Mar. 10, 2026

(30) Foreign Application Priority Data
May 28, 2024 (CN) 202410670153.0

(51) Int. Cl. G06N 20/00

(52) U.S. Cl. CPC G06N 20/00

(57) ABSTRACT

Knowledge transfer-driven method and related device for computing power energy efficiency modeling for a data center. The method steps include obtaining energy efficiency data of a source computing device and a target computing device, preprocessing the energy efficiency data of both devices to obtain key energy efficiency feature spaces of both devices respectively; constructing a cross-computing device energy efficiency model based on unbalanced optimal transport; training the model, learning differences in energy efficiency feature spaces among heterogeneous computing devices, applying the trained model to the target computing device to perform energy efficiency modeling and evaluate energy efficiency performance of the target computing device. This method improves the difficulty in data reuse, high modeling costs, and poor modeling accuracy with few samples caused by domain drift in the energy efficiency feature spaces of heterogeneous computing devices in scenarios with limited data acquisition.

### TECHNICAL FIELD

The present invention belongs to the technical field of data centers, and specifically relates to knowledge transfer-driven method and device for computing power energy efficiency modeling for data centers.

### BACKGROUND OF THE INVENTION

In recent years, with the continuous expansion of global cloud data centers, their energy consumption has also been increasing rapidly. It is estimated that in 2022, the electricity consumption of global cloud data centers reached 240-340 TWh, accounting for about 1%-1.3% of the world's total electricity consumption. Furthermore, as hyperscale public cloud providers deploy complex artificial intelligence (AI) applications, especially large language models, the energy consumption problem by data centers is further exacerbated. A massive number of heterogeneous computing devices, i.e. servers of various kinds, being the critical infrastructure in a data center, have an average resource utilization rate of 12%-18%, but their energy consumption accounts for 42% of the total energy consumption of the data center. Therefore, how to achieve efficient utilization of computing power resources has become the key to energy saving in a data center. At present, most researches on energy efficiency optimization mainly aim at improving the resource utilization efficiency of computing devices, such as parameter tuning of computing devices and dynamic scheduling of computing power resources. The commonality of these researches is to find a correlation between computing device resource characteristics and energy consumption, which is also the significance of establishing computing device energy efficiency models.

With the rapid development of machine learning (ML), its powerful nonlinear fitting ability has been used to achieve energy efficiency modeling of computing devices. For example, prior art literature “Lin W, Wu G, Wang X, et al. An artificial neural network approach to power consumption model construction for servers in cloud data centers [J]. IEEE Transactions on Sustainable Computing, 2020, 5(3): 329-340” disclosed training of an artificial neural network model for energy efficiency modeling by using energy efficiency data from servers running different types of workloads. Similarly, prior art literature “Wu W, Lin W, He L, et al. A power consumption model for cloud servers based on elman neural network [J]. IEEE Transactions on Cloud Computing, 2021, 9(4): 1268-1277” proposed a server time series energy efficiency model based on Elman neural network, thereby achieving time series prediction of computing device energy efficiency. Although numerous current ML-based computing device energy efficiency modeling methods have demonstrated superior performance, there are still two main challenges faced by energy efficiency modeling for computing devices in real data centers:

Energy Efficiency Modeling under Data-Limited Scenarios: On one hand, energy efficiency models for computing devices built on traditional ML methods often require collection of a large amount of labeled data for model training to obtain effective energy efficiency models. However, newly deployed computing devices in a data center, due to their short operating time, cannot provide sufficient energy efficiency data for model training. At the same time, due to commercial confidentiality of data centers, large volumes of energy efficiency data, which directly characterize the operational status of the data centers, are often prohibited from being disclosed externally. This leads to difficulties and high costs in collecting energy efficiency data for energy efficiency modeling for computing devices in real data centers. Therefore, how to realize energy efficiency modeling for computing devices in real data centers under data-limited scenarios is of great significance.

Cross-Device Energy Efficiency Data Reuse: On the other hand, energy efficiency models for computing devices built on traditional ML methods only perform well under the assumption that the training and test data are independently and identically distributed. However, in a real data center, to meet the computing resource needs of different users, a large number of heterogeneous computing devices are often deployed, such as general-purpose computing devices with CPUs as the computing core, and intelligent computing devices with AI chips such as GPUs, FPGAs, TPUs, NPUs as the core. Differences in hardware or workloads during operation lead to differences in energy efficiency performance and thus result in distribution drift of energy efficiency features among different computing devices, making it difficult for energy efficiency models built on traditional ML methods to generalize well. Therefore, to obtain high-precision energy efficiency models, it is necessary to collect a large amount of energy efficiency data from specific target servers for model training, resulting in high data collection costs. In fact, although there are differences in workloads or hardware among different computing devices, the data collected from different servers contain shared energy efficiency features. Traditional ML methods find it difficult to achieve effective knowledge mining in non-independently and identically distributed scenarios. Therefore, it is of great significance to energy efficiency modeling of computing devices in data centers to further mine valuable knowledge contained in the collected energy efficiency data and realize cross-device energy efficiency data reuse, so as to improve the energy efficiency modeling performance of target computing devices having only a small amount of labeled data.

### BRIEF SUMMARY OF THE INVENTION

The main purpose of the present invention is to overcome the defects and deficiencies of the prior arts and provide knowledge transfer-driven method and device for computing power energy efficiency modeling for data centers. By learning the distribution differences of energy efficiency features between source and target computing devices, it is possible to utilize valuable knowledge contained in a large amount of labeled historical energy efficiency data of the source computing device to improve energy efficiency modeling precision of the target computing device having only a minute amount of labeled energy efficiency data.

To achieve the above purpose, the present invention adopts the following technical solutions:
According to one aspect of the present invention, a knowledge transfer-driven method for computing power energy efficiency modeling for a data center is provided, comprising the following steps:
obtaining energy efficiency data of a source computing device and a target computing device; wherein the source computing device has a large amount of labeled energy efficiency data, and the target computing device has a minute amount of labeled energy efficiency data;
preprocessing the energy efficiency data of the source computing device and that of the target computing device respectively to obtain key energy efficiency feature spaces of the source computing device and the target computing device respectively; wherein said key energy efficiency feature spaces refer to features most related to energy efficiency of the source computing device and the target computing device;
constructing a cross-computing device energy efficiency model based on unbalanced optimal transport; wherein a target function of the cross-computing device energy efficiency model is to obtain an optimal unbalanced optimal transport plan and an energy efficiency model function; by optimizing the target function, both marginal and conditional distribution differences between the key energy efficiency feature spaces of the source computing device and the target computing device are learned, so that valuable knowledge about energy efficiency contained in the energy efficiency data of the source computing device is utilized to improve energy efficiency modeling precision of the target computing device having only the minute amount of labeled energy efficiency data;
training the cross-computing device energy efficiency model, learning differences in energy efficiency feature spaces among heterogeneous computing devices, and thus realizing effective energy efficiency knowledge transfer among the heterogeneous computing devices;
applying the cross-computing device energy efficiency model which is trained to the target computing device to perform energy efficiency modeling and evaluate energy efficiency performance of the target computing device.

Preferably, the step of obtaining the energy efficiency data of the source computing device and the target computing device comprises the following steps:
assigning a computing device with said large amount of labeled energy efficiency data which is historical data as the source computing device X_{S}; wherein an energy efficiency data set of the source computing device X_{S} is represented as D^{S}={x^{S}; y^{S}}, and a sample size of the labeled energy efficiency data of the source computing device X_{S} is represented as having a quantity Nₛ;
assigning a computing device with said minute amount of labeled energy efficiency data as the target computing device X_{T}, wherein an energy efficiency data set of the target computing device X_{T} is represented as D^{T}={x^{T}; y^{T}} having a sample size represented as quantity Nₜ, wherein the labeled energy efficiency data of the target computing device X^{T} is represented as

$${y}_{l}^{T} ,$$

and a sample size of the labeled energy efficiency data of the target computing device X_{T} is represented as having a quantity nₜ; and nₜ<<Nₜ<<Nₛ;
assuming a joint probability distribution of the energy efficiency feature spaces of the source computing device X_{S} is P^{S}, and that of the target computing device X_{T} is P^{T}.

Preferably, the step of preprocessing the energy efficiency data of the source computing device and that of the target computing device respectively to obtain key energy efficiency feature spaces of the source computing device and the target computing device respectively comprises the following steps:

using Principal Component Analysis (PCA) to reduce dimensionality of the key energy efficiency feature spaces of the source computing device and the target computing device, so as to obtain the key energy efficiency feature spaces of the source computing device and the target computing device respectively;
to eliminate an impact of differences in dimension and numerical range between values of the labeled energy efficiency data of different computing devices on energy efficiency model training, Min-Max normalization is applied to the values of the labeled energy efficiency data of both the source computing device and the target computing device as follows:

$${y}^{′} = \frac{y - min ( y )}{max ( y ) - min ( y )} ;$$

wherein y is the value of the labeled energy efficiency data of a corresponding computing device, max(y) and min(y) are maximum and minimum values in each energy efficiency data set respectively, and y′ is a normalized value, ranging within [0,1].

Preferably, the target function of the cross-computing device energy efficiency model is represented as:

$${min}_{f ∈ ℋ , Γ ∈ Π ( {P}^{S} , {P}_{f}^{T} )} {\sum }_{i , j} {Γ}_{i , j} C ( {x}_{i}^{S} , {y}_{i}^{S} ; {x}_{j}^{T} , f ( {x}_{j}^{T} ) ) + δ Ω ( f ) + {λ}_{1} {D}_{K L} ( {Γ}_{i , j} 1 , {P}^{S} ) + {λ}_{2} {D}_{K L} ( {Γ}_{i , j} 1 , {P}^{T} )$$

$$s . t . {y}_{j}^{T} = f ( {x}_{j}^{T} ) , 1 \leq j \leq {n}_{t}$$

wherein ƒ(·) is an energy efficiency model function in Reproducing Kernel Hilbert Space (RKHS) [symbol] ;

$${P}_{f}^{T}$$

is a joint probability distribution of unlabeled energy efficiency data of the target computing device;

$$Π ( {P}^{S} , {P}_{f}^{T} )$$

is a projection space on two joint probability distributions;

$${x}_{i}^{S} ∈ {x}^{S} and {y}_{i}^{S} ∈ {y}^{S}$$

represent an i^{th} energy efficiency feature data of the source computing device and a corresponding value thereof respectively;

$${x}_{j}^{T} ∈ {x}^{T} and {y}_{j}^{T} ∈ {y}^{T}$$

represent a j^{th} energy efficiency feature data of the target computing device and a corresponding value thereof respectively; 1 is an identity matrix; Γ_{i,j}∈Γ represents an unbalanced optimal transport plan; C(·) is a joint cost function, which includes a data sample distance between the source computing device and the target computing device, Ω(·) is a regularization term; D_{KL}(·) is Kullback-Leibler (KL) divergence, represented as D_{KL}(z)=zlog(z)−z; δ≥0 is a parameter that balances complexity between the joint cost function C(·) and the energy efficiency model function ƒ(·); λ₁, λ₂ are penalty hyperparameters; training data of the target computing device includes nₜ number of labeled energy efficiency data which are used for semi-supervised fitting of the energy efficiency model function ƒ(·), wherein

$${y}_{j}^{T} = f ( {x}_{j}^{T} ) ,$$

1≤J≤nₜ is a constraint to training of the energy efficiency model.

Preferably, one of the source computing device and the target computing device is a CPU-based general-purpose computing device and another one of the source computing device and the target computing device is an artificial intelligence-based intelligent computing device.

Preferably, the step of training the cross-computing device energy efficiency model and learning differences in the energy efficiency feature spaces among heterogeneous computing devices comprises the following steps:

Using the large amount of labeled energy efficiency data of the source computing device and the minute amount of labeled energy efficiency data of the target computing device as training data;
fixing ƒ(·) first, and then solving a transfer plan Γ; by using Majorization-Minimization algorithm, an optimized target function is iterated to obtain the transfer plan Γ;
if the transfer plan Γ is fixed, the target function is further represented as follows:

$$\text{?} {\sum }_{j = 1}^{{N}_{t}} \frac{1}{{N}_{t}} {‖ {\hat{y}}_{j} - f ( {x}_{j}^{T} ) ‖}^{2} + δ ‖ f \text{?}$$

$$s . t . {y}_{j}^{T} = f ( {x}_{j}^{T} ) , 1 \leq j \leq {n}_{t}$$

$$wherein {\hat{y}}_{j} = {N}_{t} {\sum }_{i} {Γ}_{i , j} {y}_{i}^{s}$$

is a predicted energy efficiency feature data value, and nₜ<j≤Nₜ;
eventually, the training data is used to fit the optimized target function until the energy efficiency model converges or reaches a maximum number of iterations, thus yielding an optimal energy efficiency model function ƒ(·).

Preferably, the unlabeled energy efficiency data of the target computing device is input into a trained energy efficiency model to evaluate energy efficiency of the target computing device, and Mean Squared Error (MSE) and Mean Absolute Error (MAE) are used for quantitative analysis of performance of the trained energy efficiency model.

According to a second aspect of the present invention, the present invention also provides a knowledge transfer-driven computing power energy efficiency modeling system for a data center, to implement said knowledge transfer-driven method for computing power energy efficiency modeling for the data center; the system comprises a data acquisition module, a preprocessing module, an energy efficiency model construction module, an energy efficiency model training module, and an energy efficiency evaluation module;
the data acquisition module is configured to obtain energy efficiency data of the source computing device and the target computing device; wherein the source computing device has the large amount of labeled energy efficiency data, and the target computing device has the minute amount of labeled energy efficiency data;
the preprocessing module is configured to preprocess the energy efficiency data of the source computing device and the target computing device respectively to obtain the key energy efficiency feature spaces of the source computing device and the target computing device respectively; wherein said key energy efficiency feature spaces refer to features most related to energy efficiency of the source computing device and the target computing device;
the energy efficiency model construction module is configured to construct a cross-computing device energy efficiency model based on unbalanced optimal transport; a target function of the cross-computing device energy efficiency model is to obtain the optimal unbalanced optimal transport plan and the energy efficiency model function; by optimizing the target function, both marginal and conditional distribution differences between energy efficiency of the source computing device and the target computing device are learned, so that valuable knowledge about energy efficiency contained in the energy efficiency data of the source computing device is utilized to improve energy efficiency modeling precision of the target computing device having only the minute amount of labeled energy efficiency data;
the energy efficiency model training module is configured to train the cross-computing device energy efficiency model, learn differences in energy efficiency feature spaces among heterogeneous computing devices, and thus realize effective energy efficiency knowledge transfer among heterogeneous computing devices;
the energy efficiency evaluation module is configured to apply the cross-computing device energy efficiency model which is trained to the target computing device to perform energy efficiency modeling and evaluate energy efficiency performance of the target computing device.

According to a third aspect of the present invention, the present invention provides an electronic device, comprising:
at least one processor; and
a memory in communication with said at least one processor; wherein
the memory stores a set of computer program instructions executable by said at least one processor to perform the knowledge transfer-driven method for computing power energy efficiency modeling for the data center as described above.

According to a fourth aspect of the present invention, the present invention provides a computer-readable storage medium storing a program, which, when executed by a processor, implements the knowledge transfer-driven method for computing power energy efficiency modeling for the data center as described above.

Compared to the prior arts, the present invention has the following advantages and beneficial effects:

Starting from the practical needs of energy efficiency modeling for computing devices in data centers, the present invention proposes a knowledge transfer-driven method for computing power energy efficiency modeling of specifically a computing device lacking sufficient labeled energy efficiency data, by learning the distribution differences in key energy efficiency feature spaces between the source and target computing devices, so that valuable knowledge about energy efficiency contained in the large amount of labeled historical energy efficiency data of the source computing device is utilized to improve energy efficiency modeling precision of the target computing device having only the minute amount of labeled energy efficiency data. The method according to the present invention compensates for the deficiencies of existing methods, improves the generalization performance of energy efficiency modeling for target computing device, lowers the data acquisition cost in real data centers, and enhances the practicality of energy efficiency modeling methods in real-world data centers.

### BRIEF DESCRIPTION OF THE DRAWINGS

To clearly illustrate the technical solutions in the embodiments of the present invention, the following is a brief description of the drawings required to describe the embodiments. It is evident that the accompanying drawings illustrate only some but not all of the possible embodiments, and other drawings may be obtained by those skilled in the art based on the accompanying drawings given that no inventive effort is required.

FIG. 1 is a flowchart of a knowledge transfer-driven energy efficiency modeling method for a data center according to an embodiment of the present invention;

FIG. 2 is a schematic structural diagram of a knowledge transfer-driven energy efficiency modeling system for a data center according to an embodiment of the present invention;

FIG. 3 is a schematic structural diagram of an electronic device according to an embodiment of the present invention.

### DETAILED DESCRIPTION OF THE INVENTION

To facilitate those skilled in the art to better understand the present invention, the technical solutions of the present invention will be described clearly and thoroughly below with reference to the drawings. It is clear that the described embodiments are only some but not all of the embodiments. Based on the embodiments described in the present invention, other embodiments obtainable by those skilled in the art without inventive efforts shall also fall within the scope of protection of the present invention.

Where an “embodiment” is mentioned, it means that specific features, structures, or characteristics described in connection with the embodiment may be included in at least one embodiment of the present application. The appearances of this phrase in various places in the description do not necessarily refer to the same embodiment, nor is such “embodiment” considered an independent or optional embodiment which is exclusive against other embodiments. Those skilled in the art will explicitly and implicitly understand that the described embodiments in the present application can be combined with other embodiments.

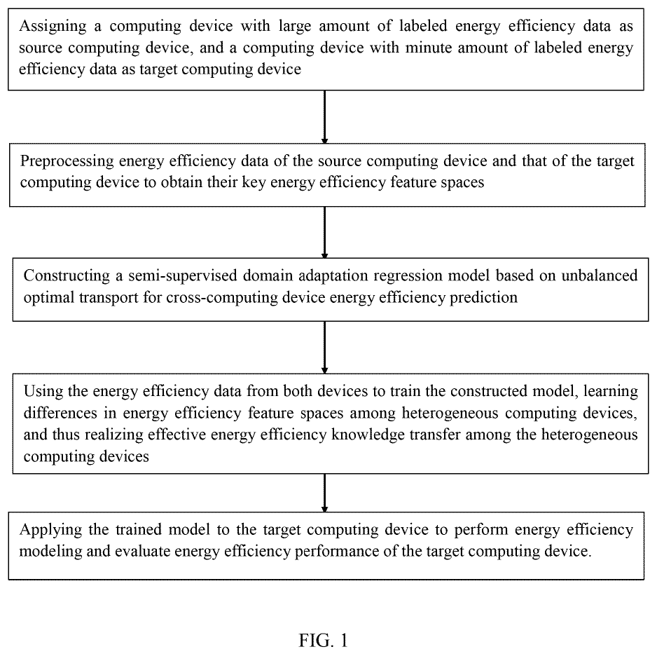

With reference to FIG. 1, a knowledge transfer-driven method for computing power energy efficiency modeling in a data center according to this embodiment comprises the following steps:

Step 1: Assigning a computing device with a large amount of labeled historical energy efficiency data as a source computing device X_{S}; wherein an energy efficiency data set of the source computing device X_{S} is represented as D^{S}={x^{S}; y^{S}}, and a sample size of labeled energy efficiency data is represented as having a quantity Nₛ; simultaneously, assigning a computing device with minute amount of labeled energy efficiency data as a target computing device X_{T}, wherein an energy efficiency data set of the target computing device X_{T} is represented as D^{T}={x^{T}; y^{T}} having a sample size represented as quantity Nₜ, where the labeled energy efficiency data is represented as,

$${y}_{l}^{T} ,$$

and a sample size of the labeled energy efficiency data is represented as having a quantity nₜ; assuming a joint probability distribution of energy efficiency feature spaces of the source computing device X_{S} is P^{S}, and that of the target computing device X_{T} is P^{T}. Note that nₜ<<Nₜ<<Nₛ.

Step 2: Preprocessing energy efficiency data of the source computing device and the target computing device to obtain key energy efficiency feature spaces of the source computing device and the target computing device respectively.

Further, in order that the key energy efficiency feature spaces of the source computing device and the target computing device are ensured while obtaining key energy efficiency features of both the source computing device and the target computing device, PCA (Principal Component Analysis) is first used to reduce dimensionality of the key energy efficiency feature spaces of the source computing device and the target computing device. And then, analyzing differences in key energy efficiency feature spaces of different kinds of computing devices in the data center, including but not limited to general-purpose computing devices (CPU-based) and intelligent computing devices (AI-based, such as GPU, FPGA, TPU, NPU, etc.-based), and exploring feasibility of energy efficiency knowledge transfer among the different kinds of computing devices.

At the same time, to eliminate the impact of differences in dimension and numerical range between values of labeled energy efficiency data of different computing devices on energy efficiency model training, Min-Max normalization is applied to values of labeled energy efficiency data of both the source computing device and the target computing device as follows:

$${y}^{′} = \frac{y - min ( y )}{max ( y ) - min ( y )} ;$$

wherein y is a value of labeled energy efficiency data of a corresponding computing device, max(y) and min(y) are maximum and minimum values in each energy efficiency data set respectively, and y′ is a normalized label, ranging within [0,1].

Step 3: Constructing a semi-supervised domain adaptation regression model based on unbalanced optimal transport; and a target function thereof is represented as:

$$\text{?} {\sum }_{i , j} {Γ}_{i , j} C ( {x}_{i}^{S} , {y}_{i}^{S} ; {x}_{j}^{T} , f ( {x}_{j}^{T} ) ) + δ Ω ( f ) + {λ}_{1} {D}_{KL} ( {Γ}_{i , j} 1 , {P}^{S} ) + {λ}_{2} {D}_{KL} ( {Γ}_{i , j} 1 , {P}^{T} )$$

$$s . t . {y}_{j}^{T} = f ( {x}_{j}^{T} ) , 1 \leq j \leq {n}_{t}$$

wherein ƒ(·) is an energy efficiency model function in RKHS (Reproducing Kernel Hilbert Space) [symbol] ; Γ_{i,j}∈Γ represents an unbalanced optimal transport plan,

$${P}_{f}^{T}$$

is a joint probability distribution for the target computing device in a semi-supervised setting;

$$\prod ( {P}^{S} , {P}_{f}^{T} )$$

Is a projection space or two joint probability distributions;

$${x}_{i}^{S} ∈ {x}^{S} and {y}_{i}^{S} ∈ {y}^{S}$$

represent an ith energy efficiency feature data of the source computing device and a corresponding value thereof respectively;

$${x}_{j}^{T} ∈ {x}^{T} and {y}_{j}^{T} ∈ {y}^{T}$$

represent a j^{th} energy efficiency feature data of the target computing device and a corresponding value thereof respectively; Ω(·) is a regularization term; D_{KL}(·) is KL (Kullback-Leibler) divergence, represented as D_{KL}(z)=zlog(z)−z; δ≥0 is a parameter that balances complexity between a cost function C(·) and the energy efficiency model function ƒ(·). Further, training data of the target computing device includes nₜ number of labeled energy efficiency data which are used for semi-supervised fitting of the energy efficiency model function ƒ(·), wherein

$${y}_{j}^{T} = f ( {x}_{j}^{T} ) ,$$

1≤j≤nₜ is a constraint to training of the energy efficiency model. C(·) is a joint cost function, which includes a data sample distance between the source computing device and the target computing device, and a loss function L(·) determining a difference between corresponding energy efficiency feature data values, represented as:

$$C ( {x}_{i}^{S} , {y}_{i}^{S} ; {x}_{j}^{T} , {y}_{j}^{T} ) = \{ \begin{matrix}σ q ( {x}_{i}^{S} , {x}_{j}^{T} ) + L ( {y}_{i}^{S} , {y}_{j}^{T} ) , & if 1 \leq j \leq {n}_{t} \\ σ q ( {x}_{i}^{S} , {x}_{j}^{T} ) + L ( {y}_{i}^{S} , f ( {x}_{j}^{T} ) ) , & if {n}_{t} < j \leq {N}_{t}\end{matrix}$$

where q(·) is a function measuring a difference of energy efficiency data

$${x}_{i}^{S}$$

source computing device and energy efficiency data

$${x}_{j}^{T}$$

of the target computing device, and σ is a hyperparameter that balances a difference of key energy efficiency feature spaces and a value of the loss function L(·).

In summary, an ultimate objective of the above target function of step 3 is to find an optimal unbalanced optimal transport plan Γ and the energy efficiency model function ƒ(·). By optimizing the above target function, both marginal and conditional distribution differences between energy efficiency of the source computing device and the target computing device are learned, so that valuable knowledge about energy efficiency contained in the large amount of labeled historical energy efficiency data of the source computing device is utilized to improve energy efficiency modeling precision of the target computing device having only a minute amount of labeled energy efficiency data.

Step 4: Using the large amount of labeled historical energy efficiency data of the source computing device and the minute amount of labeled energy efficiency data as training data to train the semi-supervised domain adaptation regression model constructed in Step 3, so as to obtain the optimal unbalanced optimal transport plan Γ and the energy efficiency model function ƒ(·). Given a predetermined training data set, due to smoothness of the target function defined in Step 3, training of the semi-supervised domain adaptation regression model can proceed by fixing one variable and optimizing another one; specifically, fixing ƒ(·) first, and then solving Γ. By using Majorization-Minimization algorithm, an optimized target function obtained from Step 3 is iterated as follows:

$${Γ}^{( k + 1 )} = {diag ( \frac{{P}^{S}}{{Γ}^{( k )} {1}_{m}} )}^{\frac{1}{2}} ( {Γ}^{( k )} ⊙ exp ( - \frac{C}{2 λ} ) ) {diag ( \frac{{P}^{T}}{{Γ}^{( k )} {1}_{n}} )}^{\frac{1}{2}}$$

where diag(·) represent extraction of diagonal elements of a diagonal matrix, ⊙ is matrix (element-wise) multiplication, exp(·) is an exponential function, 1ₘ is m-dimensional identity matrix, and 1ₙ is n-dimensional identity matrix; let λ=λ₁=λ₂, and let k be a number of iteration.

When Γ is fixed, the target function constructed in Step 3 can be further represented as follows:

$$\text{?} {\sum }_{j = 1}^{{N}_{t}} \frac{1}{{N}_{t}} {‖ {\hat{y}}_{j} - f ( {x}_{j}^{T} ) ‖}^{2} + δ ‖ f \text{?} \\ s . t . {y}_{j}^{T} = f ( {x}_{j}^{T} ) , 1 \leq j \leq {n}_{t} \\ wherein {\hat{y}}_{j} = {N}_{t} {\sum }_{i} {Γ}_{i , j} {y}_{i}^{s} ,$$

(nₜ<j≤Nₜ) is a predicted energy efficiency feature data value.

Further, rewrite the above target function in kernel form as:

$$\text{?} {\sum }_{j = 1}^{{N}_{t}} \frac{1}{{N}_{t}} {‖ {\hat{y}}_{j} - {\sum }_{j = 1}^{{N}_{t}} {ω}_{j} k ( {x}_{i}^{T} , {x}_{j}^{T} ) ‖}^{2} + δ ‖ ω \text{?} s . t . {y}_{j}^{T} = {\sum }_{j = 1}^{{n}_{t}} {ω}_{j} k ( {x}_{i}^{T} , {x}_{j}^{T} ) , 1 \leq j \leq {n}_{t}$$

wherein k(·) is a kernel function, ωⱼ∈ω is a weight.

$${y}_{j}^{T} = {\sum }_{j = 1}^{{n}_{t}} {ω}_{j} k ( {x}_{i}^{T} , {x}_{j}^{T} ) ,$$

1≤j≤nₜ is a constraint that constrains model training.

Alternatively, rewrite the above target function in Lagrangian form as:

$$F = {( {y}_{l}^{T} - K ω )}^{T} ( {y}_{l}^{T} - K ω ) + δ {ω}^{T} K ω + {ρ}^{T} ( IK ω - {Y}^{T} ) \\ wherein {Y}^{T} = {[ {y}_{l}^{T} ; 0 ]}_{{N}_{t} \times 1}^{T} and I = ( \begin{matrix}{I}_{{n}_{t} \times {n}_{t}} & 0 \\ 0 & 0\end{matrix} ) .$$

Further, ρ is a parameter, such that K is represented as:

$$K = ( \begin{matrix}k ( {x}_{1}^{T} , {x}_{1}^{T} ) & k ( {x}_{1}^{T} , {x}_{{n}_{t}}^{T} ) \\ k ( {x}_{{n}_{t}}^{T} , {x}_{1}^{T} ) & k ( {x}_{{n}_{t}}^{T} , {x}_{{n}_{t}}^{T} )\end{matrix} )$$

By setting a first derivative of the above Lagrangian form to zero (0), an optimal parameter is obtained as:

$$[ \begin{matrix}{ω}^{*} \\ {ρ}^{*}\end{matrix} ] = {[ \begin{matrix}2 ( δ I + K ) & I \\ IK & 0\end{matrix} ]}^{- 1} [ \begin{matrix}2 {y}_{l}^{T} \\ {Y}^{T}\end{matrix} ]$$

Step 5: Unlabeled energy efficiency data of the target computing device is input into a trained model obtained from Step 4 to evaluate energy efficiency of the target computing device, and MSE (Mean Squared Error) and MAE (Mean Absolute Error) are used for quantitative analysis of performance of the trained model as follows:

$$M S E = \frac{1}{M} {\sum }_{i = 1}^{M} {( {p}_{i} - {\hat{p}}_{i} )}^{2} \\ MAE = \frac{1}{M} {\sum }_{i = 1}^{M} \vert {p}_{i} - {\hat{p}}_{i} \vert$$

wherein M is a number of test samples, pᵢ and \hat{p}ᵢ represent true and predicted values for the target computing device respectively.

In another embodiment, feasibility of the present invention is verified, comprising mainly the following two steps:

Step 1: Experimental Setup, as follows:

Data set selection: This embodiment is implemented based on historical data set SURFsara of a real data center, wherein the current embodiment tests the energy efficiency data collected from six CPU architecture computing devices and three GPU architecture computing devices operating for three consecutive days. According to the current embodiment, a source computing device has 15,000 labeled energy efficiency data, and the target computing device has 500 energy efficiency data, with only 10 labeled. Table 1 below shows the detailed settings the devices.

TABLE 1
Computing devices used for testing

| Device Type | Device ID |
|---|---|
| CPU Architecture | r10n20, r11n15, r12n6, r13n30, r25n30, r27n13 |
| GPU Architecture | r30n5, r31n1, r31n2 |

Comparative Methods: The present invention is compared with four popular traditional ML energy efficiency modeling methods (Linear Regression, SVM, AdaBoost, Random Forest) and two transfer learning-based energy efficiency modeling methods (JDOT, DARE-GRAM).

Simulations: Two scenarios of cross-computing device energy efficiency modeling are set for performance analysis-cross-homogeneous (CPU-CPU) and cross-heterogeneous (CPU-GPU) device modeling.

Step 2: Performance Comparison, as detailed in the following:

The present embodiment compares the performance between the method proposed by the present invention and traditional ML-based cross-computing device energy efficiency modeling methods. It can be seen that the method proposed by the present invention demonstrates more superior performance in different task settings. In contrast, traditional ML methods perform more poorly due to their inability to handle the differences in energy efficiency feature spaces among different computing devices. The comparison results are shown in Table 2 below.

TABLE 2
Comparison of performance between the present invention and traditional
ML-based cross-computing device energy efficiency modeling methods

| | Method | Linear Regression | | SVM | | AdaBoost |
|---|---|---|---|---|---|---|
| | task | MSE | MAE | MSE | MAE | MSE |
| cross- | r10n20 -> r25n30 | 0.484071434 | 0.667959465 | 0.330867262 | 0.560212565 | 0.366727321 |
| homogeneous | r11n15 -> r25n30 | 0.549531583 | 0.703349892 | 0.621592449 | 0.75309031 | 0.449726717 |
| | r13n30 -> r25n30 | 0.346334457 | 0.57070984 | 0.506015022 | 0.681256579 | 0.205968023 |
| cross- | r10n20 -> r31n1 | 2.50765462 | 1.460841594 | 0.803672003 | 0.890254709 | 0.472181246 |
| heterogeneous | r11n15 -> r31n1 | NaN | NaN | 0.483733181 | 0.690391824 | 0.491649764 |
| | r13n30 -> r31n1 | NaN | NaN | 0.604373632 | 0.771571316 | 0.731263665 |
| | Method | AdaBoost | RandomForest | | Present invention | |
| | task | MAE | MSE | MAE | MSE | MAE |
| cross- | r10n20 -> r25n30 | 0.587648846 | 0.483644627 | 0.667713778 | 0.101993272 | 0.251724367 |
| homogeneous | r11n15 -> r25n30 | 0.643734374 | 0.375739283 | 0.59181596 | 0.105175402 | 0.256056886 |
| | r13n30 -> r25n30 | 0.436204487 | 0.744419312 | 0.825051801 | 0.0785157 | 0.187895479 |
| cross- | r10n20 -> r31n1 | 0.679848262 | 0.507017016 | 0.698361667 | 0.121861996 | 0.185593819 |
| heterogeneous | r11n15 -> r31n1 | 0.69527202 | 0.541825728 | 0.724276061 | 0.125720791 | 0.17673252 |
| | r13n30 -> r31n1 | 0.847817442 | 0.816243395 | 0.893572874 | 0.173060425 | 0.261527717 |

The present embodiment also compares performance between the method proposed by the present invention and transfer learning-based cross-homogeneous computing device energy efficiency modeling methods. It can be seen that the method proposed by the present invention is significantly superior to other methods in cross-homogeneous computing device energy efficiency modeling tasks. The comparison results are shown in Table 3 below.

TABLE 3
Comparison of performance between the present invention and transfer learning-based
cross-homogeneous computing device energy efficiency modeling methods

| Method | JDOT | | DARE-GRAM | | Present invention | |
|---|---|---|---|---|---|---|
| Task (cross-homogeneous) | MSE | MAE | MSE | MAE | MSE | MAE |
| r10n20 -> r25n30 | 0.564884841 | 0.676151213 | 0.581609309 | 0.703300297 | 0.101993272 | 0.251724367 |
| r10n20 -> r12n6 | 0.545122558 | 0.676166382 | 0.827293217 | 0.907246292 | 0.060414741 | 0.190714661 |
| r10n20 -> r27n13 | 0.366690318 | 0.487464877 | 0.521596909 | 0.628340874 | 0.166831708 | 0.314521816 |
| r11n15 -> r25n30 | 0.541747532 | 0.651830365 | 0.626884043 | 0.733682752 | 0.105175402 | 0.256056886 |
| r11n15 -> r12n6 | 0.534774048 | 0.665601751 | 0.702225506 | 0.799246609 | 0.04947768 | 0.148274645 |
| r11n15 -> r27n13 | 0.381041138 | 0.50740502 | 0.463046551 | 0.580921173 | 0.162720863 | 0.296676699 |
| r13n30 -> r25n30 | 0.520757594 | 0.634297429 | 0.66762656 | 0.743957698 | 0.0705157 | 0.187895479 |
| r13n30 -> r12n6 | 0.507446465 | 0.633023419 | 0.747374594 | 0.861020386 | 0.059283512 | 0.173304483 |
| r13n30 -> r27n13 | 0.369038744 | 0.505279687 | 0.522288799 | 0.644975007 | 0.154421238 | 0.272723754 |
| r25n30 -> r10n20 | 0.552454584 | 0.678703339 | 0.663064241 | 0.754992843 | 0.471477647 | 0.616136163 |
| r12n6 -> r10n20 | 0.484190493 | 0.63712527 | 0.375715345 | 0.56257385 | 0.45581184 | 0.607373957 |
| r27n13 -> r10n20 | 0.389366673 | 0.504874016 | 0.119466245 | 0.308774799 | 0.116604279 | 0.304162435 |
| r25n30 -> r11n15 | 0.489632498 | 0.642647365 | 0.663598061 | 0.770945728 | 0.445621465 | 0.601142201 |
| r12n6 -> r11n15 | 0.544997193 | 0.677859154 | 0.408058167 | 0.581492722 | 0.429707942 | 0.59007555 |
| r27n13 -> r11n15 | 0.297278168 | 0.427992131 | 0.131924629 | 0.32946682 | 0.113822352 | 0.30399146 |
| r25n30 -> r13n30 | 0.503914902 | 0.654815488 | 0.609038174 | 0.749291539 | 0.50043371 | 0.657202318 |
| r12n6 -> r13n30 | 0.50658924 | 0.668889957 | 0.519894063 | 0.68432039 | 0.484658823 | 0.646565446 |
| r27n13 -> r13n30 | 0.354861123 | 0.473866506 | 0.069039546 | 0.245486096 | 0.09885206 | 0.266656843 |
| avg. | 0.469710451 | 0.600221854 | 0.512207998 | 0.643901993 | 0.224879124 | 0.371399953 |

The present embodiment also compares performance between the method proposed by the present invention and transfer learning-based cross-heterogeneous computing device energy efficiency modeling methods. It can be seen that the method proposed by the present invention is also significantly superior to other methods in cross-heterogeneous computing device energy efficiency modeling tasks, further demonstrating the effectiveness of the method proposed by the present invention. The comparison results are shown in Table 4 below.

TABLE 4
Comparison of performance between the present invention and transfer learning-based
cross-heterogeneous computing device energy efficiency modeling methods

| Method | JDOT | | DARE-GRAM | | Present invention | |
|---|---|---|---|---|---|---|
| Task (cross-heterogeneous) | MSE | MAE | MSE | MAE | MSE | MAL |
| r10n20 -> r30n5 | 0.638855209 | 0.744718607 | 0.398915619 | 0.624641657 | 0.128960669 | 0.224020746 |
| r10n20 -> r31n1 | 0.652737794 | 0.762786582 | 0.773696244 | 0.873621881 | 0.121861996 | 0.185593819 |
| r10n20 -> r31n2 | 0.657292931 | 0.766726093 | 0.667713583 | 0.815341592 | 0.126188042 | 0.18757582 |
| r11n15 -> r30n5 | 0.605761524 | 0.709789339 | 0.44907698 | 0.659384072 | 0.154694516 | 0.230079328 |
| r11n15 -> r31n1 | 0.626418975 | 0.732215258 | 0.698003292 | 0.835262001 | 0.125720791 | 0.17673252 |
| r11n15 -> r31n2 | 0.621814626 | 0.729348096 | 0.673284531 | 0.812856615 | 0.129505733 | 0.179674072 |
| r12n6 -> r30n5 | 0.094031353 | 0.242616107 | 0.103900872 | 0.322336584 | 0.058390949 | 0.120468571 |
| r12n6 -> r31n1 | 0.055531219 | 0.199265599 | 0.032976061 | 0.164068177 | 0.016194401 | 0.077965671 |
| r12n6 -> r31n2 | 0.054369939 | 0.198415945 | 0.026628485 | 0.155816898 | 0.01712571 | 0.082026239 |
| r13n30 -> r30n5 | 0.576111943 | 0.687228837 | 0.507699788 | 0.697037637 | 0.064575973 | 0.173932885 |
| r13n30 -> r31n1 | 0.588031199 | 0.70087735 | 0.588951051 | 0.739338398 | 0.173060425 | 0.261527717 |
| r13n30 -> r31n2 | 0.581086918 | 0.69431831 | 0.722477376 | 0.84917146 | 0.167129456 | 0.251922825 |
| r25n30 -> r30n5 | 0.098492022 | 0.222313077 | 0.193099618 | 0.429172337 | 0.058421638 | 0.107719938 |
| r25n30 -> r31n1 | 0.074831401 | 0.199928928 | 0.071980797 | 0.265756875 | 0.013417118 | 0.071897953 |
| r25n30 -> r31n2 | 0.075863377 | 0.20181401 | 0.073273979 | 0.26518023 | 0.013857979 | 0.070188459 |
| r27n13 -> r30n5 | 0.483325392 | 0.641613448 | 0.253375739 | 0.503358305 | 0.084345778 | 0.246754371 |
| r27n13 -> r31n1 | 0.567656116 | 0.734241792 | 0.288043588 | 0.536601663 | 0.080863541 | 0.197998401 |
| r27n13 -> r31n2 | 0.565571263 | 0.731644199 | 0.289605796 | 0.538113773 | 0.089146585 | 0.203577262 |
| avg. | 0.423209622 | 0.54999231 | 0.403699458 | 0.560392231 | 0.090192294 | 0.169425366 |

It should be noted that, in the above mentioned method embodiments, for the sake of simplicity, they are all described as a series of actions. However, those skilled in the art should be aware that the present invention is not limited by the described sequence of actions, and, according to the present invention, some steps can be performed in other sequences or simultaneously.

Based on the same idea as the knowledge transfer-driven computing power energy efficiency modeling method in a data center according to the above embodiments, the present invention also provides a knowledge transfer-driven computing power energy efficiency modeling system in a data center, which can be used to implement the aforementioned knowledge transfer-driven computing power energy efficiency modeling method. For ease of illustration, the schematic structural diagram of the knowledge transfer-driven computing power energy efficiency modeling system according to this embodiment only shows the elements related to this embodiment of the present invention. Those skilled in the art can understand that the illustrated structure does not limit the system and may include more or fewer elements than illustrated, or certain elements may be combined, or arranged differently.

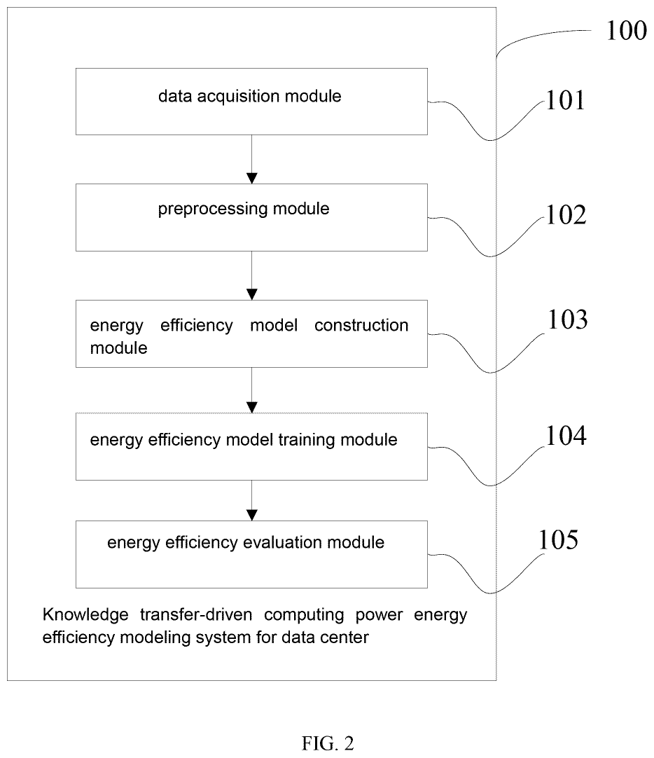

With reference to FIG. 2, in another embodiment of the present application, a knowledge transfer-driven computing power energy efficiency modeling system 100 for a data center is provided, comprising a data acquisition module 101, a preprocessing module 102, an energy efficiency model construction module 103, an energy efficiency model training module 104, and an energy efficiency evaluation module 105;
the data acquisition module 101 is configured to obtain energy efficiency data of the source computing device and the target computing device; wherein the source computing device has the large amount of labeled energy efficiency data, and the target computing device has the minute amount of labeled energy efficiency data;
the preprocessing module 102 is configured to preprocess the energy efficiency data of the source computing device and the target computing device respectively to obtain the key energy efficiency feature spaces of the source computing device and the target computing device respectively;
the energy efficiency model construction module 103 is configured to construct a cross-computing device energy efficiency model based on unbalanced optimal transport. A target function of the cross-computing device energy efficiency model is to obtain the optimal unbalanced optimal transport plan and the energy efficiency model function. By optimizing the target function, both marginal and conditional distribution differences between the key energy efficiency feature spaces of the source computing device and the target computing device are learned, so that valuable knowledge about energy efficiency contained in the large amount of labeled energy efficiency data of the source computing device is utilized to improve energy efficiency modeling precision of the target computing device having only the minute amount of labeled energy efficiency data;
the energy efficiency model training module 104 is configured to train the cross-computing device energy efficiency model, learn differences in energy efficiency feature spaces among heterogeneous computing devices, and thus realize effective energy efficiency knowledge transfer among heterogeneous computing devices;
the energy efficiency evaluation module 105 is configured to apply the cross-computing device energy efficiency model which is trained to the target computing device to perform energy efficiency modeling and evaluate energy efficiency performance of the target computing device.

It should be noted that the knowledge transfer-driven computing power energy efficiency modeling system of the present invention corresponds to the knowledge transfer-driven computing power energy efficiency modeling method of the present invention.

Therefore, the technical features and beneficial effects described in the above embodiments of the knowledge transfer-driven computing power energy efficiency modeling method, as detailed above in the method embodiments, also apply to the embodiments of the knowledge transfer-driven computing power energy efficiency modeling system, and so will not be repeated herein.

In addition, the assignment of program logics to each module in the embodiment of the knowledge transfer-driven computing power energy efficiency modeling system as detailed above is only given by way of examples. In practical applications, depending on, for example, configuration requirements of relevant hardware or convenience of software implementation, a function described above as implemented by a certain module may be assigned to a different module. That is to say, the internal structure of the knowledge transfer-driven computing power energy efficiency modeling system may be divided into different modules to accomplish all or part of the functions described above.

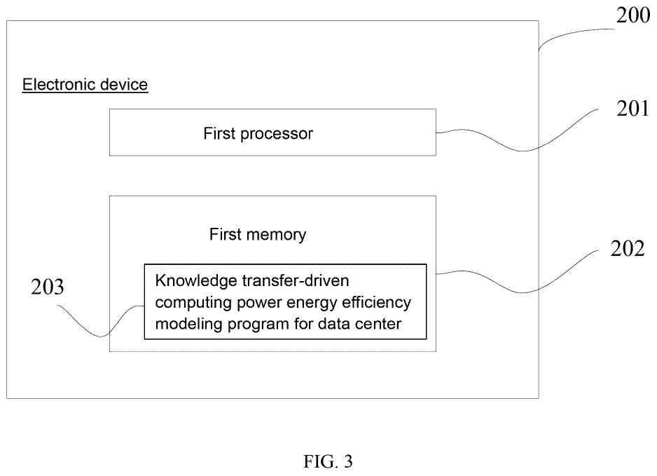

With reference to FIG. 3, according to an embodiment of the present invention, an electronic device 200 for implementing the knowledge transfer-driven computing power energy efficiency modeling method in the data center is provided. The electronic device 200 comprises a first processor 201, a first memory 202, and a bus, and may also comprise a computer program, such as a knowledge transfer-driven computing power energy efficiency modeling program 203, stored in the first memory 202 and executable on the first processor 201.

The first memory 202 at least comprises one type of readable storage medium, such as flash memory, mobile hard disk, multimedia card, card-type storage (such as SD or DX storage, etc.), magnetic storage, disk, optical disk, etc. In some embodiments, the first memory 202 may be an internal storage unit of the electronic device 200, such as a mobile hard disk of the electronic device 200. In other embodiments, the first memory 202 may be an external storage device of the electronic device 200, such as a plug-in mobile hard disk, Smart Media Card (SMC), Secure Digital (SD) card, Flash Card, etc. Further, the first memory 202 may include both the internal storage unit and the external storage device of the electronic device 200. The first memory 202 may be used not only to store application software and various data installed on the electronic device 200, such as the codes of the knowledge transfer-driven computing power energy efficiency modeling program 203, but also to temporarily store data that has been output or will be output.

In some embodiments, the first processor 201 may be composed of integrated circuit(s), such as a single packaged integrated circuit or multiple integrated circuits with the same or different functions, including different combinations of one or more central processing units (CPU), microprocessors, digital processing chips, graphics processors, and various control chips. The first processor 201 is a Control Unit of the electronic device 200 configured to connect all components of the electronic device 200 through various interfaces and circuits, and to perform various functions and process data for the electronic device 200 by running or executing programs or modules stored in the first memory 202 and calling data stored in the first memory 202.

FIG. 3 only shows the components of the electronic device 200. Those skilled in the art can understand that the structure shown in FIG. 3 does not limit the electronic device 200 and may include fewer or more components than illustrated in FIG. 3, or certain components may be combined or arranged differently.

The knowledge transfer-driven computing power energy efficiency modeling program 203 stored in the first memory 202 of the electronic device 200 is a combination of multiple instructions that can realize the following when being executed on the first processor 201:
obtaining energy efficiency data of the source computing device and the target computing device; wherein the source computing device has the large amount of labeled energy efficiency data, and the target computing device has the minute amount of labeled energy efficiency data;
preprocessing the energy efficiency data of the source computing device and the target computing device respectively to obtain the key energy efficiency feature spaces of the source computing device and the target computing device respectively;
   constructing a cross-computing device energy efficiency model based on unbalanced optimal transport. A target function of the cross-computing device energy efficiency model is to obtain the optimal unbalanced optimal transport plan and the energy efficiency model function. By optimizing the target function, both marginal and conditional distribution differences between the key energy efficiency feature spaces of the source computing device and the target computing device are learned, so that valuable knowledge about energy efficiency contained in the large amount of labeled energy efficiency data of the source computing device is utilized to improve energy efficiency modeling precision of the target computing device having only the minute amount of labeled energy efficiency data;
   training the cross-computing device energy efficiency model, learning differences in energy efficiency feature spaces among heterogeneous computing devices, and thus realizing effective energy efficiency knowledge transfer among heterogeneous computing devices;
   applying the cross-computing device energy efficiency model which is trained to the target computing device to perform energy efficiency modeling and evaluate energy efficiency performance of the target computing device.

Further, if the modules/units integrated in the electronic device 200 are realized as software function units and sold or used as an independent product, they can be stored in a non-volatile computer-readable storage medium. The computer-readable storage medium may include any entity or device, recording medium, USB drive, mobile hard drive, disk, optical disk, computer memory, or read-only memory (ROM), capable of carrying computer programing codes.

Those skilled in the art can understand that all or part of the processes in the above method embodiments can be completed by instructing related hardware through a computer program, which can be stored in a non-volatile computer-readable storage medium. When the computer program is executed, it may include the processes as described in the above method embodiments. Any reference to storage, memory, database, or other media in the embodiments provided in this application may include non-volatile and/or volatile memory. Non-volatile memory may include ROM, PROM, EPROM, EEPROM, or flash; volatile memory may include RAM or external cache. As an illustration and not limitation, RAM is available in various forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus DRAM (RDRAM), direct Rambus DRAM (DRDRAM), and memory bus DRAM (RDRAM), etc.

The above technical features may be combined arbitrarily. For the sake of simplicity, not all possible combinations of the various technical features in the above embodiments are described, but as long as contradiction does not exist, any possible combinations should be regarded as being within the scope of the specification.

The above embodiments are only preferred embodiments of the present invention, but the implementation of the present invention is not limited to the above embodiments. Any changes, modifications, substitutions, combinations, or simplifications made without departing from the spirit and principles of the present invention should be regarded as alternatives that can achieve equivalent technical effects, and should also be included in the scope of protection of the present invention.

1. A knowledge transfer-driven method for computing power energy efficiency modeling for a data center, comprising the following steps:
obtaining energy efficiency data of a source computing device and a target computing device; wherein the source computing device has a large amount of labeled energy efficiency data, and the target computing device has a minute amount of labeled energy efficiency data;
preprocessing the energy efficiency data of the source computing device and that of the target computing device respectively to obtain key energy efficiency feature spaces of the source computing device and the target computing device respectively; wherein said key energy efficiency feature spaces refer to features most related to energy efficiency of the source computing device and the target computing device;
constructing a cross-computing device energy efficiency model based on unbalanced optimal transport; wherein a target function of the cross-computing device energy efficiency model is to obtain an optimal unbalanced optimal transport plan and an energy efficiency model function; by optimizing the target function, both marginal and conditional distribution differences between the key energy efficiency feature spaces of the source computing device and the target computing device are learned, so that valuable knowledge about energy efficiency contained in the energy efficiency data of the source computing device is utilized to improve energy efficiency modeling precision of the target computing device having only the minute amount of labeled energy efficiency data;
training the cross-computing device energy efficiency model, learning differences in energy efficiency feature spaces among heterogeneous computing devices, and thus realizing effective energy efficiency knowledge transfer among the heterogeneous computing devices;
applying the cross-computing device energy efficiency model which is trained to the target computing device to perform energy efficiency modeling and evaluate energy efficiency performance of the target computing device.

2. The knowledge transfer-driven method of claim 1, wherein the step of obtaining the energy efficiency data of the source computing device and the target computing device comprises the following steps:
assigning a computing device with said large amount of labeled energy efficiency data which is historical data as the source computing device X_{S}; wherein an energy efficiency data set of the source computing device X_{S} is represented as D^{S}={x^{S}; y^{S}}, and a sample size of the labeled energy efficiency data of the source computing device X_{S} is represented as having a quantity Nₛ;
assigning a computing device with said minute amount of labeled energy efficiency data as the target computing device X_{T}, wherein an energy efficiency data set of the target computing device X_{T} is represented as D^{T}={x^{T}; y^{T}} having a sample size represented as quantity Nₜ, wherein the labeled energy efficiency data of the target computing device X_{T} is represented as
$${y}_{l}^{T} ,$$
and a sample size of the labeled energy efficiency data of the target computing device X_{T} is represented as having a quantity nₜ; and nₜ<<Nₜ<<Nₛ;
assuming a joint probability distribution of the energy efficiency feature spaces of the source computing device X_{S} is P^{S}, and that of the target computing device X_{T} is P^{T}.

3. The knowledge transfer-driven method of claim 1, wherein the step of preprocessing the energy efficiency data of the source computing device and that of the target computing device respectively to obtain key energy efficiency feature spaces of the source computing device and the target computing device respectively comprises the following steps:
using Principal Component Analysis (PCA) to reduce dimensionality of the key energy efficiency feature spaces of the source computing device and the target computing device, so as to obtain the key energy efficiency feature spaces of the source computing device and the target computing device respectively;
to eliminate an impact of differences in dimension and numerical range between values of the labeled energy efficiency data of different computing devices on energy efficiency model training, Min-Max normalization is applied to the values of the labeled energy efficiency data of both the source computing device and the target computing device as follows:
$${y}^{′} = \frac{y - min ( y )}{max ( y ) - min ( y )} ;$$
wherein y is the value of the labeled energy efficiency data of a corresponding computing device, max(y) and min(y) are maximum and minimum values in each energy efficiency data set respectively, and y′ is a normalized value, ranging within [0,1].

4. The knowledge transfer-driven method of claim 1, wherein the target function of the cross-computing device energy efficiency model is represented as:
$$\text{?} {\sum }_{i , j} {Γ}_{i , j} C ( {x}_{i}^{S} , {y}_{i}^{S} ; {x}_{j}^{T} , f ( {x}_{j}^{T} ) ) + δ Ω ( f ) + {λ}_{1} {D}_{KL} ( {Γ}_{i , j} 1 , {P}^{S} ) + {λ}_{2} {D}_{KL} ( {Γ}_{i , j} 1 , {P}^{T} ) \\ s . t . {y}_{j}^{T} = f ( {x}_{j}^{T} ) , 1 \leq j \leq {n}_{t}$$
wherein ƒ(·) is an energy efficiency model function in Reproducing Kernel Hilbert Space (RKHS) [symbol] ; P_{ƒ}^{T} is a joint probability distribution of unlabeled energy efficiency data of the target computing device;
$$Π ( {P}^{S} , {P}_{f}^{T} )$$
is a projection space of two joint probability distributions;
$${x}_{i}^{S} ∈ {x}^{S} and {y}_{i}^{S} ∈ {y}^{S}$$
represent an i^{th} energy efficiency feature data of the source computing device and a corresponding value thereof respectively;
$${x}_{j}^{T} ∈ {x}^{T} and {y}_{j}^{T} ∈ {y}^{T}$$
represent a j^{th} energy efficiency feature data of the target computing device and a corresponding value thereof respectively; 1 is an identity matrix; Γ_{i,j}∈Γ represents an unbalanced optimal transport plan; C(·) is a joint cost function, which includes a data sample distance between the source computing device and the target computing device, Ω(·) is a regularization term; D_{KL}(·) is Kullback-Leibler (KL) divergence, represented as D_{KL}(z)=zlog(z)−z; δ≥0 is a parameter that balances complexity between the joint cost function C(·) and the energy efficiency model function ƒ(·); λ₁, λ₂ are penalty hyperparameters; training data of the target computing device includes nₜ number of labeled energy efficiency data which are used for semi-supervised fitting of the energy efficiency model function ƒ(·), wherein
$${y}_{j}^{T} = f ( {x}_{j}^{T} ) ,$$
1≤j≤nₜ is a constraint to training of the energy efficiency model.

5. The knowledge transfer-driven method of claim 4, wherein one of the source computing device and the target computing device is a CPU-based general-purpose computing device and another one of the source computing device and the target computing device is an artificial intelligence-based intelligent computing device.

6. The knowledge transfer-driven method of claim 4, wherein the step of training the cross-computing device energy efficiency model and learning differences in the energy efficiency feature spaces among heterogeneous computing devices comprises the following steps:
using the large amount of labeled energy efficiency data of the source computing device and the minute amount of labeled energy efficiency data of the target computing device as training data;
fixing ƒ(·) first, and then solving a transfer plan Γ; by using Majorization-Minimization algorithm, an optimized target function is iterated to obtain the transfer plan Γ;
if the transfer plan Γ is fixed, the target function is further represented as follows:
$$\text{?} {\sum }_{j = 1}^{{N}_{t}} \frac{1}{{N}_{t}} {‖ {\hat{y}}_{j} - f ( {x}_{j}^{T} ) ‖}^{2} + δ ‖ f \text{?} \\ s . t . {y}_{j}^{T} = f ( {x}_{j}^{T} ) , 1 \leq j \leq {n}_{t} \\ wherein {\hat{y}}_{j} = {N}_{t} {\sum }_{i} {Γ}_{i , j} {y}_{i}^{s}$$
is a predicted energy efficiency feature data value, and nₜ<j≤Nₜ;
eventually, the training data is used to fit the optimized target function until the energy efficiency model converges or reaches a maximum number of iterations, thus yielding an optimal energy efficiency model function ƒ(·).

7. The knowledge transfer-driven method of claim 4, wherein the unlabeled energy efficiency data of the target computing device is input into a trained energy efficiency model to evaluate energy efficiency of the target computing device, and Mean Squared Error (MSE) and Mean Absolute Error (MAE) are used for quantitative analysis of performance of the trained energy efficiency model.

8. A knowledge transfer-driven computing power energy efficiency modeling system for a data center, to implement said knowledge transfer-driven method for computing power energy efficiency modeling for the data center of any one of claims 1 to 7; the system comprises a data acquisition module, a preprocessing module, an energy efficiency model construction module, an energy efficiency model training module, and an energy efficiency evaluation module;
the data acquisition module is configured to obtain energy efficiency data of the source computing device and the target computing device; wherein the source computing device has the large amount of labeled energy efficiency data, and the target computing device has the minute amount of labeled energy efficiency data;
the preprocessing module is configured to preprocess the energy efficiency data of the source computing device and the target computing device respectively to obtain the key energy efficiency feature spaces of the source computing device and the target computing device respectively; wherein said key energy efficiency feature spaces refer to features most related to energy efficiency of the source computing device and the target computing device;
the energy efficiency model construction module is configured to construct a cross-computing device energy efficiency model based on unbalanced optimal transport; a target function of the cross-computing device energy efficiency model is to obtain the optimal unbalanced optimal transport plan and the energy efficiency model function; by optimizing the target function, both marginal and conditional distribution differences between energy efficiency of the source computing device and the target computing device are learned, so that valuable knowledge about energy efficiency contained in the energy efficiency data of the source computing device is utilized to improve energy efficiency modeling precision of the target computing device having only the minute amount of labeled energy efficiency data;
the energy efficiency model training module is configured to train the cross-computing device energy efficiency model, learn differences in energy efficiency feature spaces among heterogeneous computing devices, and thus realize effective energy efficiency knowledge transfer among heterogeneous computing devices;
the energy efficiency evaluation module is configured to apply the cross-computing device energy efficiency model which is trained to the target computing device to perform energy efficiency modeling and evaluate energy efficiency performance of the target computing device.

9. An electronic device, comprising:
at least one processor; and
a memory in communication with said at least one processor; wherein
the memory stores a set of computer program instructions executable by said at least one processor to perform the knowledge transfer-driven method for computing power energy efficiency modeling for the data center of any one of claims 1 to 7.

10. A computer-readable storage medium storing a program, which, when executed by a processor, implements the knowledge transfer-driven method for computing power energy efficiency modeling for the data center of any one of claims 1 to 7.
